(19) United States
(12) Patent Application Publication
(10) Pub. No.: US 2012/0037827 A1
(43) Pub. Date: Feb. 16, 2012

(54) Marine, gate, ball and related valves

(76) Inventor: Seann Pavlik, Fort Lauderdale, FL (US)

(21) Appl. No.: 12/806,473

(22) Filed: Aug. 14, 2010

(51) Int. Cl. F16K 5/06

(52) U.S. Cl. 251/315.06

(57) ABSTRACT

A ball valve or the like for placement within a fluid conduit including: an element having a generally spherical geometry in fluid-tight relation to an interior diameter of the valve, and a fluid flow through the geometry, the element having an integral radial member extending externally through a slot to an outer housing, a degree of fluid flow through the fluid flow port changeable by rotation of the integral member and spherical geometry element. The valve also includes a solid cylindrical body having a longitudinal axis, a lower base integral with an outwardly extending part of the integral member of the generally spherical element and, at an opposite base thereof, a surface including at least a female recess engagable by a male extension of a wrench. The wrench may effect a full or partial opening or closure of by the incremental reciprocation, either forwardly or backwardly, of a handle.

### FIELD OF THE INVENTION

The present invention relates to various valves of types, commonly used in fluid flow applications in the marine, fire control and related industrial applications.

### BACKGROUND OF THE INVENTION

Ball, gate, cock, plug and butterfly valves are characterized by use of a large sphere or cylinder within the path of flow of the valve. Such spheres are provided with a hole or port along the axis or middle thereof, so that when the port is aligned with the input and output of the valve, full and unimpeded flow of fluid will occur. When such sphere is rotated, the port therethrough is turned perpendicular to the walls of the valve thereby blocking the flow.

Turning or rotation of the internal sphere of the ball, gate or cock valve is accomplished through the provision of a handle or knob extending integrally from said sphere and externally through the walls of the valve so that it may be engaged by a special-purpose wrench having an aperture near to an end thereof in which the aperture is complemental in geometry to that of the integrally extending handle of the sphere of the valve. A limitation with such valves is that, in most applications, the special-purpose wrench is attached, typically by a nut or bolt, to the integral handle by which the valve may be opened or closed. Such handles, in many applications, can be very large or long and, thereby, limiting of the space or area within which the ball valve or the like is disposed. Further, in certain application as in the holds or bottom portions of large, yachts, boats, ships and the like, many dozens of such ball valves and their handles may be present in a smaller space, a result of which is to render difficult and awkward area or location of such valves which are many require that other activities also occur. Also, the conventional handle employed with a ball valve is typically lacking in precision and, for the most part, is intended to accomplish a digital, that is, complete on or off function of the valve.

The present invention is therefore directed to an improvement in ball valves, gate valves and the like which eliminate the requirement for a long, permanently attached handle to the ball valve which compromises the utility of areas of boats in which several such valves are situated. It is further directed to achieving a common means of opening or closing valves throughout a vessel, industrial facility or the like.

The present invention thus addresses the above needs in the art by provision of an adapter that permits flow through said port of said spherical element to be incrementally changed or closed without need for a permanently attached special purpose handle.

### SUMMARY OF THE INVENTION

The present invention relates to a ball valve or the like for placement within a fluid conduit. The valve includes an element having a generally spherical geometry in fluid-tight relation to an interior diameter of said valve, and a fluid flow through said geometry, said element having an integral radial member extending externally through a slot to an outer housing of said valve, a degree of fluid flow through said fluid flow port changeable by rotation of said integral member and spherical geometry element. It further includes a solid cylindrical body having a longitudinal axis, a lower base thereof integral with an outwardly extending part of said integral member of said generally spherical element and, at an opposite base thereof, a surface including at least a female recess engagable by a male extension of a wrench, whereby said wrench may effect a full or partial opening or closure of said valve by the incremental reciprocation, either forwardly or backwardly, of a handle thereof.

It is accordingly an object of the present invention to provide an adaptor for a ball valve or the like employed as a permanent part of the ball valve.

It is another object to provide an adaptor for engagement with an external handle of a ball valve or the like which may then be used with a ratchet wrench or the like to accomplish a selective full or partial opening or closing of said valve by the reciprocation, either forwardly or backwardly, of the handle of the ratchet wrench, this without need for any permanent attachment to the ratchet wrench or its handle to the external handle of the ball valve.

It is a further object to provide an adaptor of the above type which will avoid the clutter typically involved in engine rooms and the like in ships which require the continuous attachment of long wrench handles to the many such valves which are typically present within the hold or bottom of a ship or boat.

It is a yet further object of the invention to provide a means of whole or partial turn-on or turn-off of any valve of the quarter-turn of family valves inclusive of ball, butterfly, plug, cock and gate valves.

It is another object to provide an adaptor which permits full or partial turn-on or off of valves of the above nature without the requirement of a large amount of force applied to the lever of prior art cock ball wrenches and, thereby, to diminish the possibility of breakage of such handle that may occur after many years of non-use, as is typical in various applications.

It is a yet object of the present invention to provide a ratchet wrench adaptor for ball valves and the like which is reliable and precise in its degree of opening or closure of a ball valve.

It is a further object to provide an improved marine, gate, ball, cock or related valve into which an adapter of the above type is integrated.

The above and yet other objects and advantages of the present invention will become apparent from the hereinafter set forth Brief Description of the Drawings, Detailed Description of the Invention and Claims appended herewith.

### BRIEF DESCRIPTION OF THE DRAWINGS

FIG. 1 is a breakaway view showing a prior art ball valve and the special-purpose wrench associated therewith.

FIG. 2 is a front elevational view of the prior art ball valve or the like.

FIG. 3 is a perspective view of the prior art ball valve wrench.

FIG. 4 is a side elevational exploded view of the view of FIG. 1.

FIG. 5 is a perspective view of the present inventive adaptor.

FIG. 6 is an exploded view showing the manner of positioning of the inventive adaptor upon a ball valve or the like.

FIG. 7 is an assembly view of FIG. 6, however without showing the ratchet wrench used therewith.

FIG. 8 is a top view of the adaptor of FIG. 5.

FIG. 9 is a side view thereof.

FIG. 10 is a bottom view of the adaptor shown in FIG. 5.

### DETAILED DESCRIPTION OF THE INVENTION

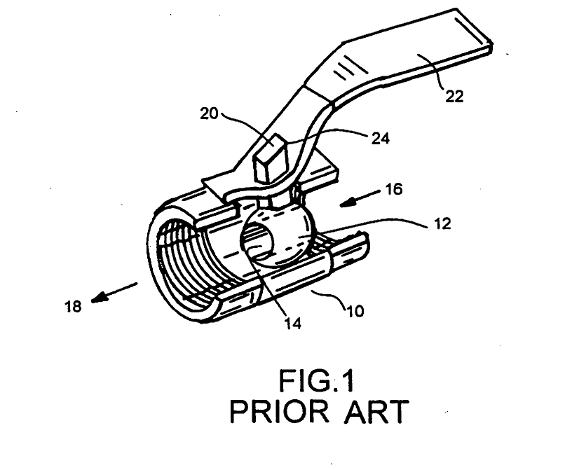

With reference to the breakaway view of FIG. 1, there is shown a prior art ball valve which, as may be noted therein, includes a valve proper 10 within which is a spherical element 12 through which is provided a hole or port 14. As related in the Background of the Invention, normal fluid flow through the valve occurs when the axis of the port is in alignment with respective input 16 and output 18 of the valve. Valves of this type are also characterized by an elongate handle 20 which, when rotated, will alter the axis of fluid flow through port 14 by up to 90 degrees in either the clockwise or counterclockwise direction. As such, valves of this family (which include butterfly, cock and plug valves) are often termed quarter turn valves and are considered durable and usually reliable to achieve an absolute shut-off or turn-on even after years of disuse, as such, representing an excellent choice of valves where shutoff or turn-on is required (often in larger volumes,) in an emergency situation. However, to insure that the capability is always present to turn on or off the flow of the valve, it is necessary to employ a special purpose wrench 22, having an aperture 24 complemental in geometry to that said extension 20 (see also FIGS. 2-4) is necessary. Furthermore, because of the emergent nature of a turn-on or disablement of flow through such valve, when a need arises, it is typical that such wrenches 22 are kept as a permanent or semi-permanent part of the assembly, as is shown in FIG. 1.

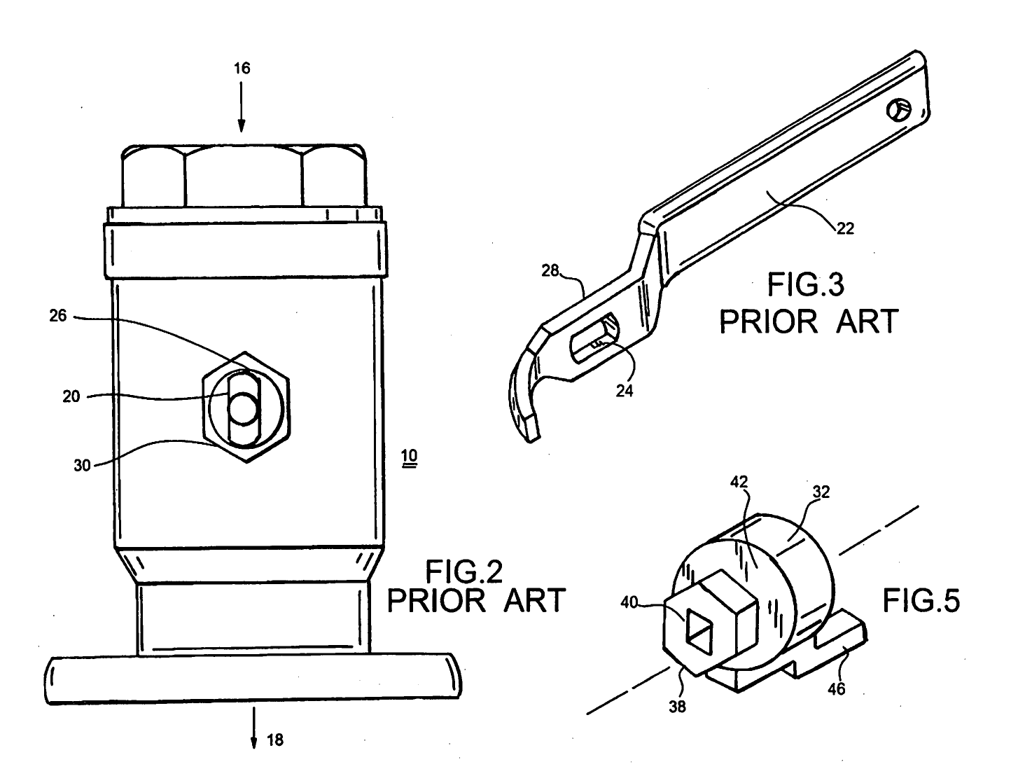

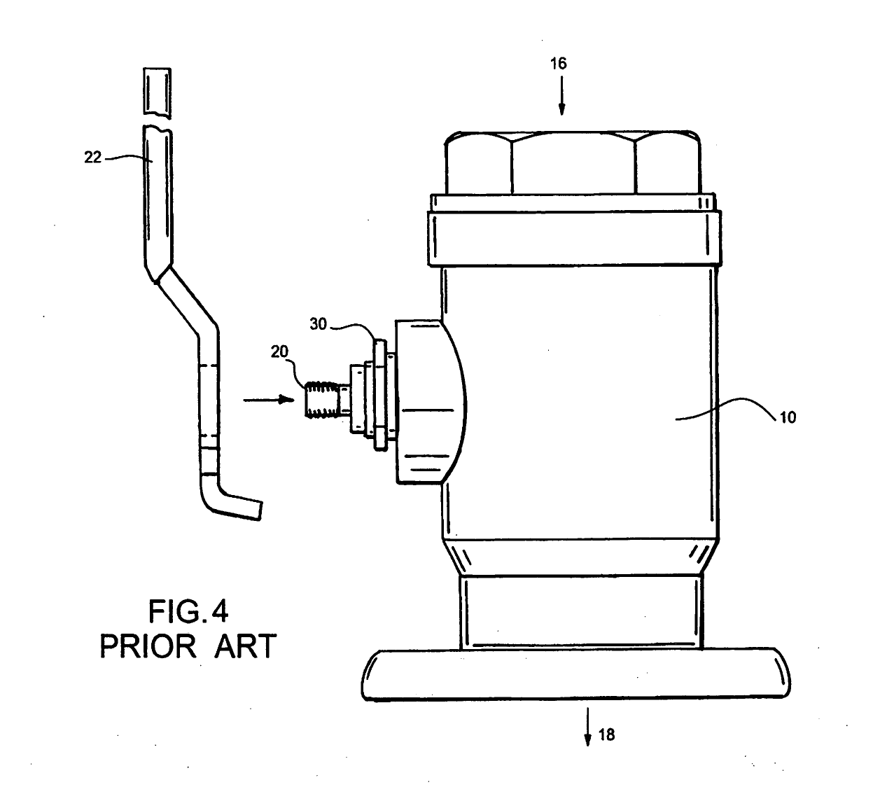

The above may be appreciated with respect to the elevational view of FIG. 2 of the valve 10, as well as the prospective view of FIG. 3, of the wrench 22. Region 26 in FIG. 2 represents the normal circumference or periphery within which rotational portion 28 of wrench 22. However, the hexagonal region 30 shown in FIG. 2 represents an emergency means by which such valves 10 may be shut-off in the event of breakage or failure of extension 20 or wrench 22. An exploded view of the illustration of the prior art shown in FIG. 1 appears in FIG. 4.

With reference to FIGS. 5 and 8-10, there is shown the present inventive wrench adapter 32, the purpose of which is to facilitate the opening and closing of ball valves and the like without requirement for a wrench 22 of the type above described and, more importantly, without requirement for a wrench handle continuously protruding from the valve as is shown in FIGS. 1 and 4.

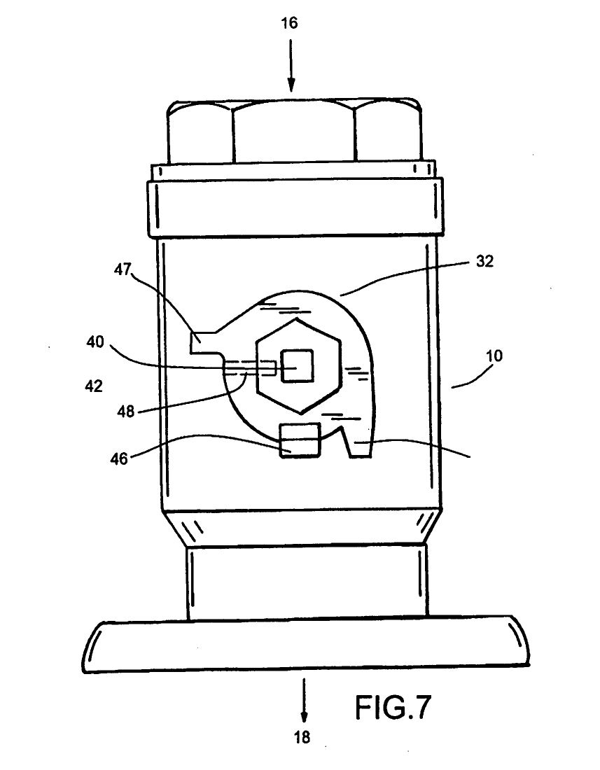

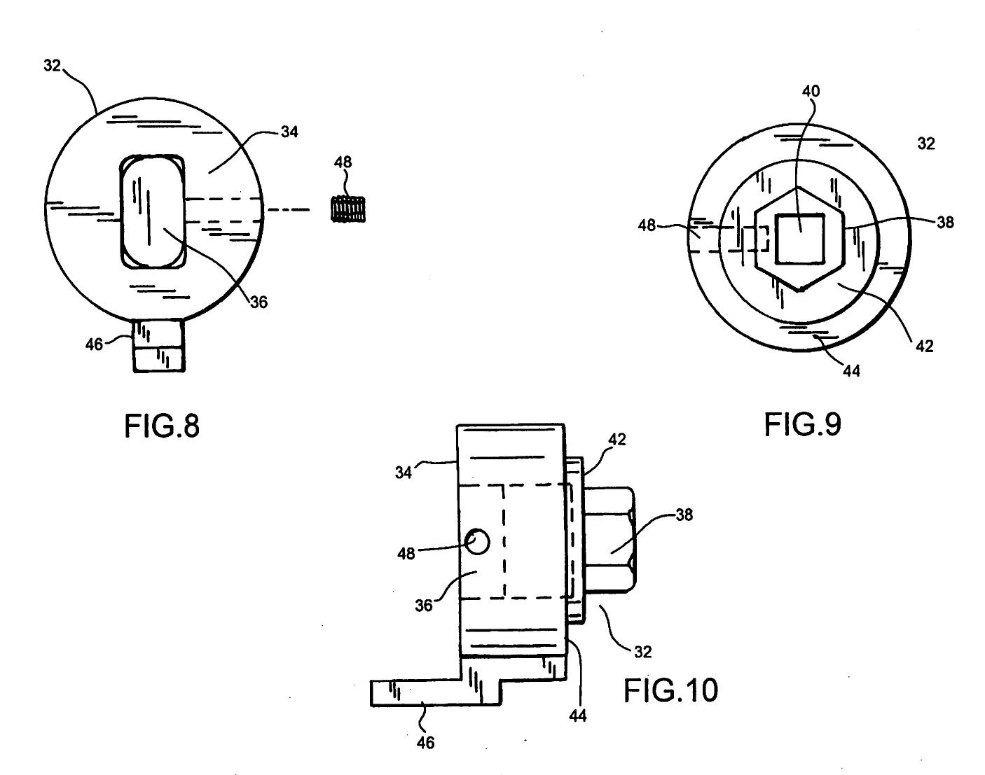

Adaptor 32 includes a bottom surface 34 (see FIG. 10) having therein an aperture 36 complemental to extension 20 of the traditional ball valve wrench, as above described. At an upper surface 44 of adaptor 32 is provided a polygonal or hex-nut 38 that includes a female recess 40 (see FIG. 8) on both hex-nut 38 and in its internal recess 40. Nut 38 protrudes from surface 42 of the adaptor 32 which in turn extends from surface 44 thereof (see FIGS. 5, 8 and 9). The present inventive adapter is also characterized by axial extension elements 46 and 47 which operate to stabilize the adapter relative to the body of the valve proper (see FIGS. 7 and 9).

As may be noted in FIG. 10, an Allen head screw 48 is employed to ensure stability of the adapter 22 relative to handle 20 of the ball valve.

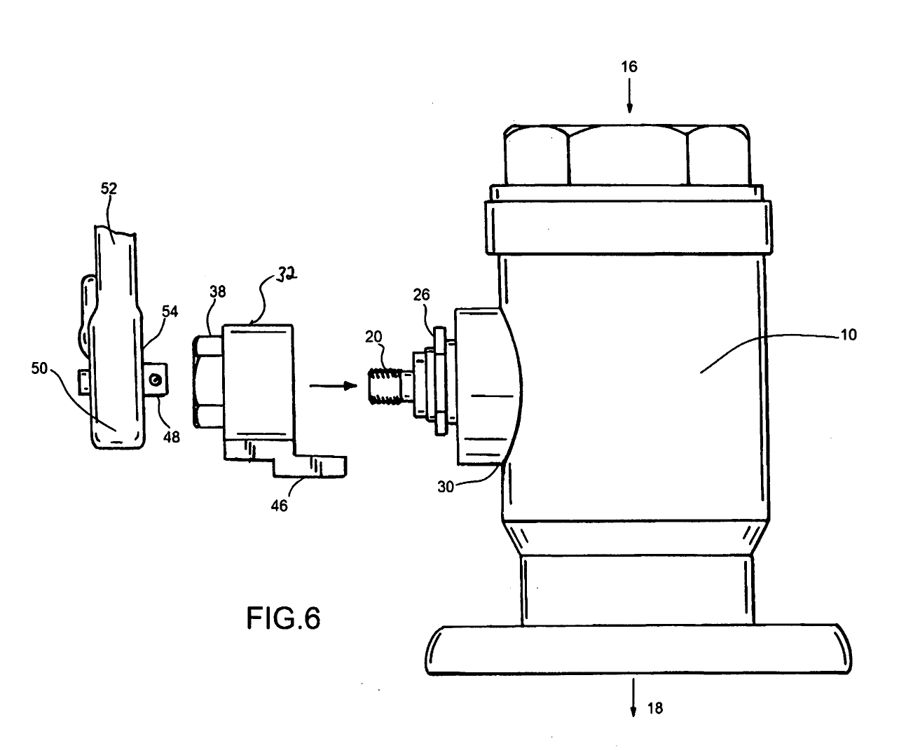

In the exploded view of FIG. 6 is shown the manner of placement of adapter 22 relative to the prior art shut-off assembly, as above described, inclusive of the constituent elements 20, 26, and 30. When adapter 22 is secured thereto through the use of Allen head screw 49, female element 48 of ratchet wrench head 50 may be inserted within female recess 38 of the above hex-nut 38 (see FIGS. 8 and 9) such that using handles 52, ratchet wrench 50 may be incrementally advanced, in the normal method of use thereof, to achieve incremental degrees of opening or closure of fluid flow through valve 10.

Thereby, the instant invention addresses not only the substantial clutter and compromise of usable space characterized by the requirement of continuous attachment of ball wrench handles 22 to the ball valve 10 or the like but, as well, incremental (on the range of 10 degrees per reciprocation) turns of handle 52 of the ratchet wrench. This renders it practical to accomplish a partial turn-on or turn-off of any valve in the quarter-turn family of valves which, as above noted, includes ball, butterfly, plug, cock and gate valves.

Another utility regarding such valves is that wrenches 22 of the prior art, generally requires a large amount of force to initiate rotation of extension 20, particularly after such a valve has not been opened or closed for many years. Also the handle thereof may break after many years of non-use. As is well known, ratchet wrenches are extremely reliable and precise wrenches, the utility and reliability of which has been established over many years.

In the embodiment shown in FIG. 6, bottom surface 54 of the ratchet wrench is positioned complementally over hex head 38 of the adapter 22. However, in an alternative embodiment of the invention, a ratchet wrench having only a female recess may be employed which directly engages hex structure 38 which, thereby, may also effect the incremental opening and closing of the ball valve without requirement for the locking of a male element 48 of the ratchet wrench to female recess 40 of the adapter.

FIG. 7, which is an assembly view, of the present invention indicates that adapter 32 may be provided with both a first extension 46 shown in FIGS. 5, 6 and 9 but, optionally, may be provided with a second extension 47 if desired. The utility of such extensions 46 and 47 is to provide an alternative means of opening or closure of the ball valve in the event failure or unavailability of the ratchet wrench 50. It, similarly, is to be appreciated that the present invention may be practiced with respect to any form of ratchet wrench whether or not provided with a square male element 48 as long as suitable engagement with female recess 40 of the adapter 32 can be accomplished.

It is also to be appreciated that the adapter 22 may employ a wholly male element, in lieu of means 40 within nut 38, to which mould mate a female ratchet wrench element 54 of wrench head 50. See FIG. 6.

It is to be understood that said adapter 32 may be integrated into said extension 20 of sphere 12 to form a novel ball valve or the like without the need for use of the adapter as a separate piece. See FIGS. 7-10

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A valve for placement within a fluid conduit, comprising:
(a) an element having a generally spherical geometry in fluid-tight relation to an interior diameter of said valve, and a fluid flow through said geometry, said element having an integral radial member extending externally through a slot to an outer housing of said valve, a degree of fluid flow through said fluid flow port changeable by rotation of said integral member and spherical geometry element; and
(b) a solid cylindrical body having a longitudinal axis, a lower base thereof integral with an outwardly extending part of said integral member of said generally spherical element and, at an opposite base thereof, a surface including at least a female recess engagable by a male extension of a wrench,
whereby said wrench may effect a full or partial opening or closure of said valve by the incremental reciprocation, either forwardly or backwardly, of a handle thereof.

2. The valve as recited in claim 1, in which said female recess of said solid body is surrounded by polygonal structure complemental to a female engaging surface of the wrench.

3. The valve as recited in claim 1, in which said wrench comprises a ratchet wrench.

4. A valve for placement within a fluid conduit, comprising:
(a) an element having a generally spherical circumference in fluid-tight relation to an interior diameter of said valve, and fluid flow port through said geometry, said spherical element having an integral radial member extending externally through a slot to an outer housing of said valve, a degree of fluid flow through said fluid flow port changeable by rotation of said integral member and spherical geometry element; and
(b) a solid cylindrical body having a longitudinal axis, a lower base thereof integral with an outwardly extending part of said integral member of said generally spherical element and, at an opposite base thereof, a surface including at least a male boss engagable by a female extension of incremental rotation wrench,
whereby said wrench may effect a full or partial opening or closure of said valve by the incremental reciprocation, either forwardly or backwardly, of a handle thereof.

5. The valve as recited in claim 4, in which said male boss includes therein a female recess engageable by a male extension of said wrench.

6. The valve as recited in claim 4, in which said wrench comprises a ratchet wrench.

7. In a ball valve or the like for placement within a fluid conduit having therein, a spherical element having a circumference in press-fit relation to the diameter of said valve and fluid flow port therethrough, said spherical element having an integral knob or handle extending externally through a slot in of the valve housing, in which an axis of fluid flow therethrough is changeable through rotation of the extension of the external handle, and a wrench adapted for opening or closing said ball valve or the like, the adapter comprising:
a solid generally cylindrical body having a vertical axis and, at a lower base thereof a recess complemental to said integral externally extending handle of said ball valve and, at an opposite base thereof, an integral surface including at least a female recess engagable by a male extension of a ratchet wrench,
whereby said ratchet wrench may effect a full or partial opening or closing of said valve by the incremental reciprocation, either forwardly or backwardly, of the handle of the ratchet wrench without need for any permanent attachment to the ball valve's external handle.

8. The valve as recited in claim 7 in which said female recess of said adapter is surrounded by polygonal structure complemental to a female engaging surface of the ratchet wrench.

9. The valve as recited in claim 7, in which said wrench comprises a ratchet wrench.
